(19) United States
(12) Patent Application Publication
(10) Pub. No.: US 2016/0121667 A1
(43) Pub. Date: May 5, 2016

(54) VEHICLE TIRE MANAGEMENT SYSTEM

(71) Applicant: The Goodyear Tire & Rubber Company, Akron, OH (US)

(72) Inventor: Robert Leon Benedict, Tallmadge, OH (US)

(21) Appl. No.: 14/529,231

(22) Filed: Oct. 31, 2014

(51) Int. Cl. B60C 23/00; H02J 7/00

(52) U.S. Cl. CPC B60C 23/004; H02J 7/0057; H02J 7/0042

(57) ABSTRACT

A tire management system for a vehicle in accordance with the present invention includes four wheels on each of which is mounted an air-inflatable tire defining a tire cavity. The system includes a bidirectional pump on each wheel for selectively pumping air from each tire to atmosphere for deflating each tire and for pumping air from atmosphere into each tire cavity for inflating each tire and a battery assembly mounted to each wheel for powering the bidirectional pumps, the battery assemblies each including a chargeable battery and a magnet for continually charging the chargeable battery.

### FIELD OF THE INVENTION

The present invention generally relates to motor vehicles, and, more specifically, to a tire pressure management system for sensing and controlling the air pressure in the tires of a motor vehicle.

### BACKGROUND OF THE INVENTION

The pressure to which the tires of a motor vehicle should be optimally inflated depends on the type of terrain over which the vehicle is to be driven. The pressure should be relatively high for hard surfaces such as paved roads, and relatively low for soft surfaces such as wet mud or loose sand.

It is possible to adjust the pressures in the individual tires to a desired value by stopping and exiting the vehicle, manually inflating the tires with a pump to increase the pressure or manually deflating the tires by opening the valves and allowing air to escape to decrease the pressure.

However, this operation is inconvenient and time consuming, and is especially undesirable in inclement weather or in an otherwise hostile environment. It also suffers from the disadvantage that it cannot be performed while the vehicle is moving.

One conventional system includes an air pump or compressor mounted on the vehicle body, and conduits leading from the compressor to valves provided in the vehicle wheels. The valves are remotely actuated by the operator from inside the vehicle to connect the compressor to the tires for inflation, or to connect the tires to the atmosphere for deflation. A disadvantage of this system is that a high pressure air connection including rotating wheel bearing air seals must be made between the conduits leading from the compressor and the rotating wheels. Such connections are difficult to construct and maintain, and a failure of the connections or valves will result in catastrophic deflation of the tires.

Another conventional system includes a high pressure reservoir and a controller valve provided on each wheel. The valves include pressure sensors which are connected to a display on a control unit mounted inside the vehicle. The valves are remotely actuated by the operator from inside the vehicle to connect the reservoirs to the tires for inflation, or to connect the tires to the atmosphere for deflation. Although this system eliminates the high pressure rotary air connections of the other system, the high pressure reservoirs must be periodically replenished from outside the vehicle. This limits the operating range of the vehicle and the number of times it may transition between operating conditions requiring different tire pressures. In addition, the valves are exposed to the atmosphere, and may be contaminated by dirt, sand or other ambient matter.

### SUMMARY OF THE INVENTION

A tire management system for a vehicle in accordance with the present invention includes four wheels on each of which is mounted an air-inflatable tire defining a tire cavity. The system includes a bidirectional pump on each wheel for selectively pumping air from each tire to atmosphere for deflating each tire and for pumping air from atmosphere into each tire cavity for inflating each tire and a battery assembly mounted to each wheel for powering the bidirectional pumps, the battery assemblies each including a chargeable battery and a magnet for continually charging the chargeable battery.

According to another aspect of the system, a sensor provided on each wheel senses air pressure in each tire cavity.

According to still another aspect of the system, a control unit in a passenger compartment of the vehicle displays air pressure sensed by the sensors and electrical interconnection units for electrically interconnecting the control unit to each bidirectional pump, each battery assembly, and each sensor for controlling application of electrical power from the battery assemblies to the sensors and the bidirectional pumps.

According to yet another aspect of the system, the vehicle includes an axle on which two wheels are rotatably mounted and each corresponding interconnection unit includes first electrical contacts which are provided on an inner periphery of each wheel and second electrical contacts which are provided on an outer periphery of the axle and electrically engaged with the respective first electrical contacts.

According to still another aspect of the system, the first electrical contacts include brushes.

A vehicle wheel on which an air-inflatable tire is mounted in accordance with the present invention forms a tire cavity. The vehicle wheel includes a rim for mounting the tire and a bidirectional pump for selectively pumping air from the tire cavity to atmosphere for deflating the tire and for pumping air from atmosphere into the tire cavity for inflating the tire.

According to another aspect of the wheel, a sensor senses the air pressure in the tire cavity.

According to still another aspect of the wheel, a control unit is mounted in a passenger compartment of the vehicle and a battery assembly is mounted to the wheel.

According to yet another aspect of the wheel, the battery assembly powers the control unit and the bidirectional pump.

According to still another aspect of the wheel, the control unit operates the bidirectional pump.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 is a vertical sectional view illustrating one example of a vehicle tire pressure management system in accordance with the present invention.

### DETAILED DESCRIPTION OF EXAMPLES OF THE PRESENT INVENTION

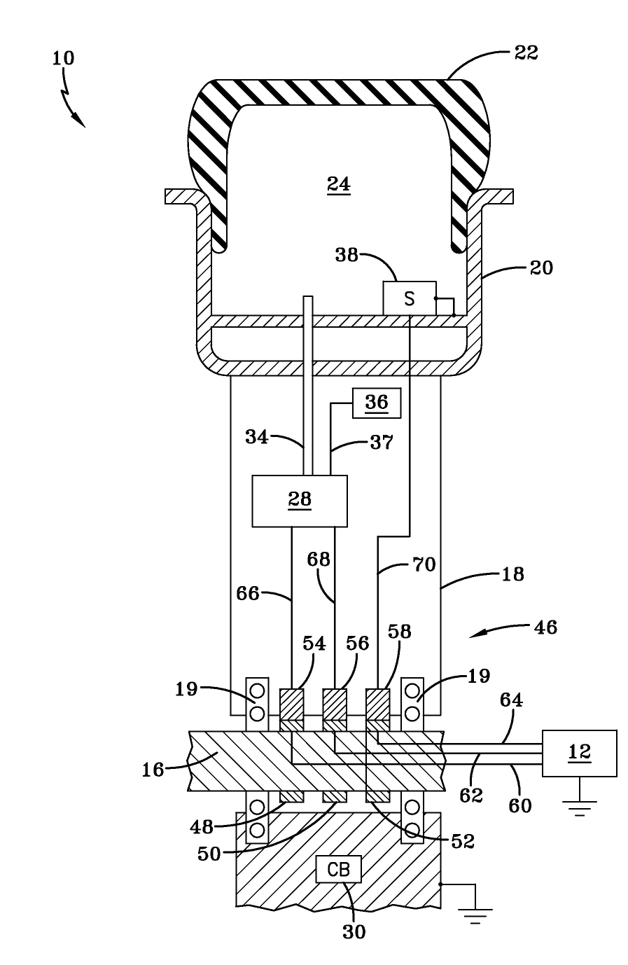

A tire pressure management system 10 in accordance with the present invention is illustrated in FIG. 1. The system 10 is similar to the system disclosed by U.S. Pat. No. 5,452,753 to Olney, herein incorporated by reference in its entirety. The system 10 may include a control unit 12 which is provided on a dashboard or other location in a driver's compartment 14 of a motor vehicle or other suitable location which is accessible without exiting the vehicle. The vehicle may include a plurality of axles, generally four, on which identical wheels with air-inflatable tires are mounted. One axle 16 is illustrated in FIG. 1. A wheel 18 is rotatably mounted on the axle 16 by bearings 19 and may include a rim 20 on which a tire 22 is mounted. A tire cavity 24 is defined between the rim 20 and the interior surface of the tire 22.

A compressor or pump 28 may be mounted on the wheel 18, preferably as close to the axle 16 as possible to minimize the moment of inertia. A counterbalance 30 may be provided in the wheel 18 at a position which is diametrically opposed to the pump 28 to eliminate the wheel imbalance created by the pump 28. The pump 28 may have one port connected to the tire cavity 24 through a conduit 34. The pump 28 may be a bi-directional unit, capable of selectively pumping air either into the tire cavity 24 or out of the tire cavity.

An air pressure sensor 38 may be mounted on the rim 20 inside the tire cavity 24 and may provide an electrical signal corresponding to the sensed tire air pressure in the tire cavity to the control unit 12. The control unit 12 may include a display for each wheel 18 displaying the tire pressure as sensed by the sensor 38, a switch or button for increasing the tire pressure, and a switch or button for decreasing the tire pressure.

One button may be depressed to increase the tire pressure from the value indicated on the display. This may cause the pump 28 to pump air from atmosphere through the conduit 34 into the tire cavity 24 to inflate the tire 22 further. The other button may be depressed to decrease the tire pressure from the value indicated on the display. This may cause the pump 28 to pump air from the tire cavity 24 through the conduit 34 to atmosphere to deflate the tire 22.

The control unit 12 may be connected to the sensor 38 and pump 28 by an interconnection unit 46. The interconnection unit 46 may include electrical contacts in the form of annular rings 48, 50, and 52 provided on the outer periphery of the axle 16. Corresponding electrical contacts in the form of brushes 54, 56, and 58 may be provided on the inner periphery of the wheel 18 to make direct electrical contact with the rings 48, 50, and 52, respectively.

The rings 48, 50 and 52 may be connected to the control unit 12 through lines 60, 62, and 64. The brushes 54, 56 may be connected to the pump 28 through lines 66, 68, whereas the brush 58 may be connected to the sensor 38 through line 70. Although not illustrated in detail, the rings 48, 50, and 52, brushes 54, 56, and 58 and lines 60, 62, 64, 66, 68, and 70 may be electrically insulated from the axle 16 and the wheel 18.

The axle 16, wheel 18, and the negative terminal of a battery 36 mounted on the wheel may be connected to the chassis of the vehicle and designated as ground. One contact of the sensor 38 may be connected to the rim 20 and thereby to ground. This may provide a complete circuit path between the sensor 38 and the control unit 12 via the line 70, brush 58, ring 52, and line 64. The pump 28 may include an electric motor including a winding (not shown) having one end connected to the control unit 12 through the line 66, brush 54, ring 48 and line 60, and an opposite end connected to the control unit 12 through the line 68, brush 56, ring 50 and line 62.

The control unit 12 and the electric motor/pump 28 may be powered by a battery assembly 36 mounted on the wheel 18. The pump 28 may thus pump air from atmosphere into the tire cavity 24, as needed, by connecting the positive terminal of the battery assembly 36 to the pump via line 37. The pumping direction may be reversed by the control unit 12 to pump air from the tire cavity 24 to atmosphere. A battery of the battery assembly 36 may be continually by the current generated by a magnet that is also part of the battery assembly.

The control unit 12 may include a separate display and buttons for each tire of the vehicle and/or a switch for switching the display readout and buttons between the tires. If the pressures in the tires are maintained approximately equal, the pressure in only one tire may be sensed, and only one display and buttons may be provided. In this case, the buttons may be connected to cause inflation or deflation of all of the tires simultaneously. The control unit 12 may further sense the pressures in all of the tires, compute and display the average thereof, and inflate or deflate all of the tires together based on the displayed average pressure. As yet another alternative, the control unit 12 may be designed to automatically, rather than manually, regulate the pressures in the tires to a value set on the display. In this case, the buttons may be used to adjust the display readout up or down to a newly desired value of tire pressure.

While the present invention has been particularly shown and described with reference to particular examples thereof, it will be understood by those skilled in the art that various changes may be made and equivalents substituted for elements thereof without departing from the scope of the present invention. In addition, many modifications may be made to adapt a particular situation or material to the teachings of the present invention without departing from the scope thereof. Therefore, it is intended that the present invention not be limited to the particular examples disclosed herein, but that the present invention will include all embodiments falling within the scope of the appended claims.

What is claimed:

1. A tire management system for a vehicle including four wheels on each of which is mounted an air-inflatable tire defining a tire cavity comprising:
a bidirectional pump on each wheel for selectively pumping air from each tire to atmosphere for deflating each tire and for pumping air from atmosphere into each tire cavity for inflating each tire; and
a battery assembly mounted to each wheel for powering the bidirectional pumps, the battery assemblies each including a chargeable battery and a magnet for continually charging the chargeable battery.

2. The tire management system as set forth in claim 1 further comprising a sensor provided on each wheel for sensing air pressure in each tire cavity.

3. The tire management system as set forth in claim 2 further comprising a control unit provided in a passenger compartment of the vehicle for displaying air pressure sensed by the sensors and electrical interconnection units for electrically interconnecting the control unit to each bidirectional pump, each battery assembly, and each sensor for controlling application of electrical power from the battery assemblies to the sensors and the bidirectional pumps.

4. The tire management system as set forth in claim 3 wherein the vehicle includes an axle on which two wheels are rotatably mounted and each corresponding interconnection unit includes first electrical contacts which are provided on an inner periphery of each wheel and second electrical contacts which are provided on an outer periphery of the axle and electrically engaged with the respective first electrical contacts.

5. The tire management system as set forth in claim 4 wherein the first electrical contacts include brushes.

6. A vehicle wheel on which an air-inflatable tire is mounted to form a tire cavity comprising:
a rim for mounting the tire; and
a bidirectional pump for selectively pumping air from the tire cavity to atmosphere for deflating the tire and for pumping air from atmosphere into the tire cavity for inflating the tire.

7. The wheel as set forth in claim 6 further comprising a sensor for sensing the air pressure in the tire cavity.

8. The wheel as set forth in claim 7 further comprising a control unit mounted in a passenger compartment of the vehicle and a battery assembly mounted to the wheel.

9. The wheel as set forth in claim 8 wherein the battery assembly powers the control unit and the bidirectional pump.

10. The wheel as set forth in claim 9 wherein the control unit operates the bidirectional pump.
